(19) United States
(12) Patent Application Publication
(10) Pub. No.: US 2006/0177244 A1
(43) Pub. Date: Aug. 10, 2006

(54) Image forming roller

(75) Inventors: Yuichi Hasegawa, Ito-shi (JP); Junji Nagasawa, Sunto-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NITTO KOGYO CO., LTD., Tokyo (JP); AKRON RUBBER CO., LTD., Numadu-shi (JP)

(21) Appl. No.: 11/347,603

(22) Filed: Feb. 6, 2006

(30) Foreign Application Priority Data
Feb. 8, 2005 (JP) 2005-031886
Nov. 4, 2005 (JP) 2005-320892
Dec. 16, 2005 (JP) 2005-363367

(51) Int. Cl. G03G 15/08; B05C 1/08; F16C 13/00

(52) U.S. Cl. 399/286; 492/56; 492/18; 399/279

(57) ABSTRACT

An image forming roller according to an aspect includes a shaft, and an electrically conductive elastic layer provided to cover an outer circumferential of the shaft and having a polished surface. The shaft is made of a resin composition containing an aromatic polyamide, a glass fiber, an electrically conductive material and optionally an aliphatic polyamide, and exhibits a bending strength of 250 MPa or higher and a flexural modulus of 15 GPa or higher.

### CROSS-REFERENCE TO RELATED APPLICATIONS

This application is based upon and claims the benefit of priority from prior Japanese Patent Applications No. 2005-031886, filed Feb. 8, 2005; No. 2005-320892, filed Nov. 4, 2005; and No. 2005-363367, filed Dec. 16, 2005, the entire contents of all of which are incorporated herein by reference.

### BACKGROUND OF THE INVENTION

1. Field of the Invention

The present invention relates to an image forming roller employed in the image forming unit of an image forming device that operates by an electrophotographic mode, such as a photocopier, printer or facsimile machine, and more specifically to an image forming roller that includes a resin-based shaft.

2. Description of the Related Art

In the image forming unit of an image forming device that operates by an electrophotographic mode, such as a photocopier, printer or facsimile machine, image forming rollers that are involved in image formation, such as a transfer roller, a toner supply roller, a development roller or a cleaning roller, are employed. Conventionally, such image forming rollers have a structure in which an electrically conductive elastic layer is provided around an outer circumferential surface of a metal shaft. In recent years, there is a demand of reducing the size and mass of image forming apparatus, and attempts have been made to form a shaft from a resin composition. For example, Jpn. Pat. Appln. KOKAI Publications No. 2001-215780 and No. 2003-195601 each disclose a non-magnetic development roller made of a resin composition containing a synthetic resin such as polyamide, an electro-conducting agent, and optionally fibers. Further, Jpn. Pat. Appln. KOKAI Publication No. 2002-40798 discloses a development roller having a shaft made of an electrically conductive resin composition containing a polyamide resin and an electrically conductive material.

However, the inventors of the present invention have found the following facts in connection with the conventional resin shafts. That is, a conventional resin shaft would not have any problem if the conductive elastic layer is provided thereon only by foaming an electrically conductive elastic material within a mold in which a resin shaft is provided, or only by forming a foamed conductive elastic material into a predetermined shape and adhering it onto the resin shaft as disclosed in Jpn. Pat. Appln. KOKAI Publication No. 2003-195601 mentioned above. Further, a conventional resin shaft would not have any problem if a semi-conductive layer is provided thereon only by coating a resin shaft with a semiconductive material as disclosed in Jpn. Pat. Appln. KOKAI Publication No. 2003-195601 mentioned above. However, in the case where an outer circumferential surface of a resin shaft is covered with an electrically conductive elastic material by extrusion or the like, and then the conductive elastic material is ground while supporting the shaft at journal portions of the resin shaft, thereby forming an electrically conductive elastic layer, it has been clarified by the present inventors that the resin shaft is fractured at the journal portions while grinding, making it impossible to manufacture an image forming roller.

Meanwhile, according to another conventional technique, when an electrically conductive elastic layer is provided on a resin shaft, an uncured rubber material is applied around the resin shaft by extrusion or molding, and the rubber material is then subjected to curing. However, the glass transition point of the resin-based material is lower than the curing temperature of the rubber material, resulting in that the resin shaft is deformed and the dimensional accuracy is lowered.

The above-mentioned problem that the resin shaft is deformed by high temperature heating may be overcome by using a method wherein a shaft is press-fitted into a previously cured elastic rubber tube as it is usually carried out so when an electrically conductive elastic layer is provided on a metal shaft (see, for example, Jpn. Pat. Appln. KOKOKU Publication No. 6-55457).

However, in that case, if the inner diameter of the elastic rubber tube is excessively large with respect to the outer diameter of the resin shaft, the tube slips around the resin shaft while grinding the tube, which is carried out in a later stage. Thus, it has been found that a low accuracy of the measurement of the outer diameter of the tube causes lowering of the deflection accuracy. On the other hand, it has been found that if the inner diameter of the elastic rubber tube is excessively small, the distortion created while press-fitting the shaft into the tube remains within the tube, causing lowering of the deflection accuracy of the outer diameter of the tube, leading to blurred images.

### BRIEF SUMMARY OF THE INVENTION

Accordingly, it is a first object of the present invention to provide an image forming roller that includes a resin shaft, which will not be fractured by grinding process applied to an electrically conductive elastic material.

A second object of the present invention is to provide an image forming roller that can solve the problem occurring when an electrically conductive elastic layer is provided by press-fitting a resin shaft into a cured elastic rubber tube, thereby achieving blur-free images.

According to a first aspect of the present invention, the first object can be achieved by an image forming roller comprising a shaft and an electrically conductive elastic layer provided to cover an outer circumferential surface of the shaft and having a polished or ground surface, wherein the shaft is made of a resin composition comprising an aromatic polyamide, a glass fiber and an electrically conductive material, and exhibits a bending strength of 250 MPa or higher and a flexural modulus of 15 GPa or higher.

According to a second aspect of the present invention, the second object can be achieved by an image forming roller comprising a shaft made of a resin-based material and an electrically conductive elastic layer provided to cover an outer circumference of the shaft and having a polished or ground surface, the conductive elastic layer being formed of a previously cured electrically conductive rubber tube, wherein a ratio, de/ds, of an inner diameter de of the tube to an outer diameter, ds, of the shaft is 0.75 to 0.97, and/or a difference, ds−de, between an outer diameter, ds, of the shaft and an inner diameter, de, of the tube is 0.3 mm or more but 2.5 mm or less.

### DETAILED DESCRIPTION OF THE INVENTION

First, an image forming roller according to the first aspect of the present invention will be described.

An image forming roller according to the first aspect of the present invention comprises a shaft prepared from a resin composition containing an aromatic polyamide, a glass fiber and an electrically conductive material, and an electrically conductive elastic layer provided to cover an outer circumferential surface of the shaft.

The resin shaft of the image forming roller according to the first aspect of the present invention exhibits a bending strength of 250 MPa or higher and a flexural modulus of 15 GPa or higher. If the bending strength and the module of bending elasticity are less than these values, the resin shaft may crack while it is being ground and polished with grindstone, which is carried out after the conductive elastic layer of an electrically conductive rubber or the like is provided on the shaft. The bending strength is usually 500 MPa or less and the flexural modulus is usually 30 GPa or less.

Further, it is preferable that the shaft of the image forming roller according to the first aspect of the present invention exhibits a glass transition point of 70° C. or higher. The image forming roller is usually assembled in an image forming unit, and in many cases, it is stored under stress at a temperature of about 60° C. Further, the journal portions is heated to a temperature of about 60° C. in some cases while it is subjected to lathing process. When the glass transition point is less than 70° C., warping may occur while the roller is stored, and further the roller may be deformed while being ground, which causes deterioration of the surface accuracy. The glass transition point is usually 100° C. or less.

Further, it is preferable that the resin shaft of the image forming roller according to the first aspect of the present invention exhibits a specific gravity of 1.8 or less. If the specific gravity exceeds 1.8, the demand for the reduction of the weight of the device cannot be sufficiently satisfied. The specific gravity is usually 1.0 or higher.

Furthermore, it is preferable that the shaft of the image forming roller according to the first aspect of the present invention exhibits a volume resistivity of 1×10⁵ Ω·cm or less. A volume resistivity that exceeds 1×10⁵ Ω·cm is higher than the resistivity necessary for the conductive elastic layer provided around the outer circumference of the shaft, and therefore it is likely to cause an adverse effect on printing. The volume resistivity is usually 1×10⁰ Ω·cm or higher.

The shaft that exhibits the above-described physical properties is formed from a resin composition that contains an aromatic polyamide, glass fiber and electrically conductive particles, as mentioned above, and the composition may further contain an aliphatic polyamide.

Aromatic polyamide is a polyamide having aromatic groups in its main chain, and it can be obtained by polycondensation reaction between metaxylylenediamine and an α,ω-aliphatic dicarboxylic acid such as adipic acid, succinic acid, glutaric acid or pimelic acid. An aromatic polyamide obtained from metaxylylenediamine and adipic acid is known as polyamide MXD6.

An aliphatic polyamide has a structure of a polycondensate of a polymethylenediamine such as hexamethylenediamine with an aliphatic dicarboxylic acid, and it includes polyamide 6 or polyamide 6,6.

As the glass fiber, a conventionally known type can be employed. It is preferable that the diameter of the glass fiber is 1 to 50 μm, and the length thereof is 0.1 to 10 mm.

Preferable examples of the conducting material are carbon blacks such as channel black, furnace black, thermal black, lamp black, ketjene black and acetylene black, and carbon fibers, etc. It is preferable that the diameter of the carbon fiber should is 1 to 50 μm, and the length thereof is 0.1 to 10 mm. Carbon black and carbon fiber may be used in combination as the conducting material.

In order to impart the above-described physical properties, the resin composition preferably contains the glass fiber in an amount of 10 to 300 parts by mass and the conducting material in an amount of 0.1 to 20 parts by mass, with respect to a total of 100 parts by mass of the aromatic polyamide and the aliphatic polyamide. It is preferable that the mass ratio of the aromatic polyamide to the aliphatic polyamide is 100:0 to 50:50.

The shaft of the image forming roller according to the first aspect of the present invention can be molded by a method such as injection molding. After the shaft is formed by the injection molding, the journal portions can be finished by the lathing process. More specifically, the shaft of the image forming roller of the present invention includes a shaft body and a journal portion provided on either side of the shaft body.

The conductive elastic layer provided around the outer circumference of the shaft body can be formed of an electrically conductive rubber material, which is prepared by blending an electrically conductive substance such as carbon black or metal powder to a base material of a rubber such as silicone rubber, acrylonitrile-butadiene rubber, urethane rubber or ethylene-propylene rubber, to impart the conductivity to the rubber material. The conductive elastic layer can be formed by applying the conductive rubber material around the outer circumference of the shaft body and then grinding and polishing it with grindstone by an ordinary method. Alternatively, it can be also formed by adhering a tube body made of the conductive elastic layer around the outer circumference of the shaft body and then grinding and polishing the tube body with grindstone by an ordinary method. In either case, the grinding is carried out on the conductive elastic material formed around the outer circumference of the shaft by rotating the shaft body while supporting it at the journal portions. The final thickness of the conductive elastic layer (after grinding) is 0.2 mm or more from the viewpoint of polishing accuracy. The thickness of the conductive elastic layer after polished is usually 10 mm or less.

A micro-porous covering layer such as that disclosed in Jpn. Pat. Appln. KOKAI Publication No. 11-242383 can be provided around the outer circumferential surface of the conductive elastic layer. The micro-porous covering layer can be obtained by subjecting a reaction mixture containing a polyol, an isocyanate compound and a pore-forming agent comprising a volatile silicone oil to a reaction condition between the polyol and the isocyanate compound. The micro-porous covering layer is formed without a foaming phenomenon and therefore it does not require a mold that is necessary for a usual foaming step. The reaction mixture can contain a reactive silicone oil having active hydrogen. With the microporous covering layer thus provided, it is possible to prevent further effectively the contamination of the photosensitive drum and the occurrence of negative ghost when the image forming roller according to the first aspect of the present invention is used as a developing roller.

An image forming roller according to the second aspect of the present invention will now be described.

An image forming roller according to the second aspect of the present invention comprises a shaft made of a resin material and a polished electrically conductive elastic layer provided to cover an outer circumference of the shaft. The conductive elastic layer is made of a previously cured electrically conductive rubber tube. A ratio de/ds of an inner diameter de of the tube to an outer diameter ds of the shaft is 0.75 to 0.97, and/or a difference ds−de between an outer diameter ds of the shaft and an inner diameter de of the tube is 0.3 mm or more but 2.5 mm or less.

The resin shaft used for the image forming roller according to the second aspect of the present invention can be made of a polyamide, for example, an aromatic polyamide obtained by polycondensation reaction between metaxylylenediamine and an α,ω-aliphatic dicarboxylic acid such as adipic acid, succinic acid, glutaric acid or pimelic acid (an aromatic polyamide obtained from metaxylylenediamine and adipic acid is known as polyamide MXD6); an aliphatic polyamide such as polyamide 6 or polyamide 6,6, which is a polycondensate of a polymethylenediamine such as hexamethylenediamine and aliphatic dicarboxylic acid, and a resin such as polyacetal, polybutyleneterephthalate, polyphenylenesulfide, polyphenyleneoxide, polyethersulfone, polycarbonate, polysulfone, polyetheretherketone.

The resin material used to form the image forming roller according to the second aspect contains an electrically conductive material to impart electrical conductivity, in addition to the above resin material. As the conductive materials, use may be made of those conductive materials described in connection with the first aspect of the present invention. The conductive material can be used in an amount of 0.1 to 20 parts by mass with respect to 100 parts by mass of the resin.

The resin material may contain glass fiber. As the glass fibers, use may be made of those glass fibers described in connection with the first aspect of the present invention.

The conductive elastic layer provided on the resin shaft in the second aspect of the present invention is made of a previously cured electrically conductive rubber tube. Such a tube can be formed from an electrically conductive rubber material, which is prepared by blending a conducting substance such as carbon black or metal powder to a base material of rubber such as silicone rubber, acrylonitrile-butadiene rubber, urethane rubber or ethylene-propylene rubber, to impart conductivity to the rubber material. The tube can be prepared by extruding an uncured conductive rubber material into a tube shape and then curing it. It should be noted that only primary curing may be sufficient to cure the rubber material, or it may be preferable to conduct primary and secondary curing to cure the rubber material, depending on the type of the rubber material. For example, only primary curing process, in which the rubber material is cured at a temperature of 80° C. to 180° C. for 5 to 24 hours, may be sufficient to cure an acrylonitrile-butadiene rubber and a urethane rubber. On the other hand, it is preferable that rubber material is first subjected to primary curing under the conditions of a temperature of 100° C. to 400° C. and a curing time of 1 minute to 10 hours, and then subjected to secondary curing under the conditions of a temperature of 150° C. to 250° C. and a curing time of 1 to 24 hours. In the case of the ethylenepropylene rubber, it is preferable that the material is subjected to primary curing under the conditions of a temperature of 80° C. to 180° C. and a curing time of 5 minute to 24 hours, and then subjected to secondary curing under the conditions of a temperature of 70° C. to 150° C. and a curing time of 1 to 6 hours.

The cured rubber tube thus obtained is inflated with compressed air to expand its diameter, and the resin shaft is pushed or press-fitted into the cured tube. Then, the cured rubber tube (the conductive elastic layer) is subjected to grinding and polishing using, e.g., grindstone by an ordinary method. The final thickness of the conductive elastic layer (after polishing) is preferably 0.2 mm or more but 10 mm or less from the viewpoint of polishing accuracy. It is not required to apply an adhesive, a primer or the like between the outer circumference of the resin shaft and the inner circumference of the tube. The outer circumference of the resin shaft and the inner circumference of the tube may be directly contacted with each other.

As described above, if the inner diameter of the elastic rubber tube is excessively large with respect to the outer diameter of the resin shaft, the tube slips around the resin shaft while grinding the tube, which is carried out in a later stage. Thus, the low accuracy of the outer diameter of the tube causes lowering of the deflection accuracy. On the other hand, if the inner diameter of the elastic rubber tube is excessively small, the distortion created while pushing the shaft into the tube remains within the tube, causing lowering of the deflection accuracy of the outer diameter of the tube.

In order to solve this problem, according to the second aspect of the present invention, the ratio, de/ds, of an inner diameter, de, of the cured tube to an outer diameter, ds, of the shaft is set at 0.75 to 0.97, and/or the difference, ds−de, between an outer diameter, ds, of the shaft and an inner diameter, de, of the cured tube is set at 0.3 mm or more but 2.5 mm or less.

With the relationship thus set between the outer diameter, ds, of the shaft and the inner diameter, de, of the tube, it is possible to prevent the slippery of the tube around the resin shaft while grinding or polishing the cured tube, and the remaining of the distortion created while pushing the shaft into the tube. In this way, an image forming roller having an excellent dimensional accuracy can be obtained. The ratio, de/ds, is preferably 0.8 to 0.95. The difference, ds−de, is preferably 0.5 to 2.5 mm.

It is preferable that the resin shaft of the image forming roller according to the second aspect of the present invention exhibits a bending strength and a flexural modulus the same as those of the resin shaft of the image forming roller according to the first aspect.

Further, it is preferable that the resin shaft of the image forming roller according to the second aspect of the present invention exhibits a glass transition point the same as that of the resin shaft of the image forming roller according to the first aspect.

Furthermore, it is preferable that the resin shaft of the image forming roller according to the second aspect of the present invention exhibits a specific gravity the same as that of the resin shaft of the image forming roller according to the first aspect.

Still further, it is preferable that the resin shaft of the image forming roller according to the second aspect of the present invention exhibits a volume resistivity the same as that of the resin shaft of the image forming roller according to the first aspect.

Moreover, as in the case of the first aspect, a micro-porous covering layer can be provided around the outer circumferential surface of the conductive elastic layer (cured tub) provided around the resin shaft in the image forming roller according to the second aspect of the present invention.

The resin shaft of the image forming roller according to the second aspect of the present invention can be prepared similarly to the resin shaft according to the first aspect. Similarly, the journal portions can be provided by lathing process after the injection molding.

It should be noted that the second aspect of the present invention is particularly advantageous when it is applied to resin shafts having a glass transition point of 100° C. or less. This is because a resin shaft having such a low glass transition is readily deformable at such a high temperature at which the primary and secondary curing steps are carried out.

The image forming roller of the present invention can be provided as, besides a developing roller, a transfer roller, a toner supplying roller, a cleaning roller, etc.

Examples of the present invention will now be described in comparison with Comparative Examples. It should be noted that the present invention is not limited to these examples.

### EXAMPLES 1 TO 4 AND COMPARATIVE EXAMPLES 1 TO 3

A shaft having a diameter of 14 mm and a surface length (rubber processed portion) of 235 mm was injection molded from a respective resin composition indicated in TABLE 1 below, using: polyamide MXD6 of Mitsubishi Gas Chemical Co., Inc., as an aromatic polyamide; NOVAMID 1007J (registered trademark) of Mitsubishi Engineering Plastics Corporation, as an aliphatic polyamide; CS03-JAFT2 of Asahi Fiber-Glass Co., Ltd., as glass fiber; and #3050B of Mitsubishi Chemical Co., Ltd., as carbon black. Then, the journal portions were finished by lathing, providing a developing roller used for Printer HL-1850 of Brother Industries, Ltd. The shafts thus obtained were measured for their module of bending elasticity, bending strength, glass transition point, specific gravity and volume resistivity. The results were shown in TABLE 2. Note that Strograph V10-C of Toyo Seiki Seisaku-sho Co., Ltd was used to measure the module of bending elasticity and the bending strength, a thermal analysis device, DSC-60, of Shimadzu Corporation was used to measure the glass transition point, an electronic gravimeter, MD-200S, of Alfa Mirage Co. Ltd was used to measure the specific gravity, and a resistance meter, R8340, of Advantest Corporation was used to measure the volume resistivity.

Further, the deflection of each shaft was measured by an ordinary method. More specifically, the shaft was supported at the journal portions and rotated. The maximum value and minimum value of the displacement of the shaft at the longitudinal central portion of the shaft were measured using a laser, and the difference between these values is obtained as the deflection of the shaft. The results obtained were shown in TABLE 3 (indicated as “before high temperature heating”). Further, the deflection of the shaft after it was allowed to stand at a high temperature was measured for each shaft. More specifically, the shaft was supported at the journal portions and a load of 1 kg was applied at the central portion of the shaft. The shaft was allowed to stand in this state at a temperature of 55° C. for 5 days, and then the deflection of the shaft was measured by the above-described method. The results obtained were shown also in TABLE 3 (indicated as “after high temperature heating).

Next, an electrically conductive silicone rubber having a volume resistivity of 10⁶ Ω·cm and a JIS A hardness of 45° was applied around the outer circumferential surface of each shaft, and the rubber was ground, thereby manufacturing a rubber-coated roller having an outer diameter of 20 mm.

The deflection of the shaft after grinding the silicone rubber layer was measured by the above-described method. The results obtained were shown also in TABLE 3. While grinding the silicone rubber layer, the rubber-coated roller that includes the shaft of Comparative Example 1 had such a problem that the shaft itself cracked regardless of the grinding conditions or the rubber layer could not be evenly polished due to the deformation of the shaft, and therefore a developing roller could not be obtained. Meanwhile, with regard to the shaft of Comparative Example 2, the grinding could be somehow carried out by greatly changing the grinding conditions; however the deflection of the shaft was as significantly large as 0.2 mm (see TABLE 3).

Subsequently, 300 parts by mass of butylacetate was added to a mixture of 100 parts by mass of fluorine-containing polyol (Zeful of Daikin Industries, Ltd.) and 5 parts by mass of conductive carbon black (Cabot Corporation), and the mixture was dispersed with a disperser. Then, the resultant dispersion was added with 5 parts by mass of volatile silicone oil (KF96L of Shin-Etsu Chemical Co., Ltd.), and the mixture was stirred to obtain the main component. A urethane-modified hexamethylenediisocyanate (Duranate of Asahi Kasei Chemicals Co., Ltd.) was added to the main component in such an amount that a ratio between an equivalent of the hydroxyl group in the main component and an equivalent of the isocyanate group in the curing agent was 1:1, thereby preparing a coating material A. The coating material A was applied by spraying to have a thickness of 10 μm onto the rubber-coated shaft, air-dried, and heated at 160° C. for 40 minutes to form a desired microporous covering layer, thus preparing a developing roller.

Each developing roller thus obtained was built in Printer HL-1850 of Brother Industries, Ltd., and an image evaluation test was carried out, in which 3000 sheets of paper were fed for each case. The results obtained were shown also in TABLE 3.

As is clear from the results shown in TABLE 2, the shafts of Examples 1 to 4 each exhibit a flexural modulus of 15 GPa or more, and a bending strength of 250 MPa or more. Therefore, in each case, the deflection after grinding the coated rubber layer is small, and therefore it is possible to provide a developing roller that can provide a clear image. Further, the deflection is small after being let stand at a high temperature.

TABLE 1

Components

| | Aromatic | Aliphatic | Glass | Carbon |
|---|---|---|---|---|
| | polyamide | polyamide | fiber | black |
| Ex. 1 | 100 parts | 0 | 100 parts | 12 parts |
| | by mass | | by mass | by mass |
| Ex. 2 | 90 parts | 10 parts | 100 parts | 12 parts |
| | by mass | by mass | by mass | by mass |
| Ex. 3 | 50 parts | 50 parts | 115 parts | 12 parts |
| | by mass | by mass | by mass | by mass |
| Ex. 4 | 100 parts | 0 | 50 parts | 12 parts |
| | by mass | | by mass | by mass |
| Comp. | 0 | 100 parts | 0 | 12 parts |
| Ex. 1 | | by mass | | by mass |
| Comp. | 40 parts | 60 parts | 60 parts | 12 parts |
| Ex. 2 | by mass | by mass | by mass | by mass |
| Comp. | 100 parts | 0 | 100 parts | 6 parts |
| Ex. 3 | by mass | | by mass | by mass |

TABLE 2

| | | | Glass | | |
|---|---|---|---|---|---|
| | Flexural | Bending | transition | | Volume |
| | modulus | strength | point | Specific | resistivity |
| | (GPa) | (MPa) | (° C.) | gravity | (Ω · cm) |
| Ex. 1 | 20 | 350 | 80 | 1.5 | 5 × 10² |
| Ex. 2 | 18 | 340 | 78 | 1.5 | 3 × 10² |
| Ex. 3 | 17 | 300 | 75 | 1.5 | 2 × 10² |
| Ex. 4 | 17 | 270 | 80 | 1.4 | 4 × 10² |
| Comp. | 2.3 | 120 | 60 | 1.1 | 2 × 10² |
| Ex. 1 | | | | | |
| Comp. | 13 | 220 | 73 | 1.4 | 3 × 10² |
| Ex. 2 | | | | | |
| Comp. | 17 | 350 | 80 | 1.5 | 5 × 10⁷ |
| Ex. 3 | | | | | |

TABLE 3

| | Deflection (mm) | | | |
|---|---|---|---|---|
| | Shaft | Shaft | | |
| | (Before high | (After high | Rubber-covered | |
| | temperature | temperature | roller (after | |
| | heating) | heating) | polishing) | Image |
| Ex. 1 | 0.03 | 0.03 | 0.03 | Clear |
| Ex. 2 | 0.03 | 0.03 | 0.03 | Clear |
| Ex. 3 | 0.03 | 0.03 | 0.03 | Clear |
| Ex. 4 | 0.03 | 0.03 | 0.03 | Clear |
| Comp. | 0.03 | 0.3 | Immeasurable | Immeasurable |
| Ex. 1 | | | | |
| Comp. | 0.03 | 0.03 | 0.2 | Lateral |
| Ex. 2 | | | | streaks |
| | | | | generated |
| Comp. | 0.03 | 0.03 | 0.03 | Whit clarity |
| Ex. 3 | | | | image |
| | | | | generated |

### EXAMPLES 5 TO 9 AND COMPARATIVE EXAMPLES 4 TO 6

A resin shaft was manufactured in the same manner as in Example 1 except that the outer diameter (diameter), ds, of the shaft was 10 mm.

On the other hand, an uncured electrically conductive silicone rubber material (DY32-4036 of Dow Corning Toray Co., Ltd.) was extruded into a tube shape and then cured at 200° C. for 2 minutes (primary curing) Then, the cured material was cut into predetermined lengths and each cut material was cured at 200° C. for 4 hours (secondary curing), thereby obtaining tubes having an inner diameters, de, of 6.5 to 9.9 mm (TABLE 4) and an outer diameter of 20.6 mm. Each tube was inflated with compressed air to expand its diameter, and the shaft obtained above was pressure-fitted into the respective tube. Then, the surface of the tube was ground and polished, thus providing an image forming roller having an outer diameter of 20 mm. The volume resistivity of the conductive silicone rubber was 10⁶ Ω·cm and the JIS A hardness thereof was 45°.

Thereafter, a micro-porous covering layer was formed as in Example 1, thus preparing a developing roller.

The developing roller thus obtained was built in Printer HL-1850 of Brother Industries, Ltd., and an image evaluation test was carried out, in which 10 sheets of paper were fed. The images obtained were evaluated by the following criteria:

No blur in image . . . ◯; a little blur shown, but practically no problem . . . Δ; blur shown and practically no good . . . X.

The results obtained were shown in TABLE 4.

TABLE 4

| | Comp. | | | | | | Comp. | Comp. |
|---|---|---|---|---|---|---|---|---|
| | Ex. 4 | Ex. 5 | Ex. 6 | Ex. 7 | Ex. 8 | Ex. 9 | Ex. 5 | Ex. 6 |
| Outer diameter | 10 mm | 10 mm | 10 mm | 10 mm | 10 mm | 10 mm | 10 mm | 10 mm |
| of the shaft, ds | | | | | | | | |
| Inner diameter | 9.9 mm | 9.7 mm | 9.5 mm | 9.0 mm | 8.0 mm | 7.5 mm | 7.0 mm | 6.5 mm |
| of the tube, de | | | | | | | | |
| de/ds | 0.99 | 0.97 | 0.95 | 0.90 | 0.80 | 0.75 | 0.70 | 0.65 |
| ds − de | 0.1 mm | 0.3 mm | 0.5 mm | 10 mm | 2.0 mm | 2.5 mm | 3.0 mm | 3.5 mm |
| Evaluation | X | Δ | ◯ | ◯ | ◯ | Δ | X | X |
| of image | | | | | | | | |

The developing roller of Comparative Example 4 showed the occurrence of slippery due to the rotational torque during the grinding process applied to the cured silicone rubber, and therefore polishing precision was deteriorated. As a result, blur was shown in the image as indicated in TABLE 4. The developing rollers of Comparative Examples 5 and 6 each showed that the distortion, which was created when the resin shaft is pressure-fitted into the cured silicone rubber tube, remained in the cured silicone rubber tube, which resulted in blur in the image as indicated in TABLE 4. In contrast, the developing rollers of Examples 5 to 9 according to the present invention each provided a clear image without blur as indicated in TABLE 4.

### EXAMPLES 10 TO 12

Developing rollers were manufactured in the same manner as in Examples 5 to 9 except that the polyamide resin compositions used in Examples 2 to 3 were employed to form the shafts.

The developing roller thus obtained was measured in terms of image evaluation in the manner as in Examples 5 to 9. The results obtained were similar to those of Examples 5 to 9.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming roller comprising a shaft, and an electrically conductive elastic layer provided to cover an outer circumferential surface of the shaft and having a polished surface,
wherein the shaft is formed of a resin composition containing an aromatic polyamide, a glass fiber, an electrically conductive material and optionally an aliphatic polyamide, and exhibits a bending strength of 250 MPa or higher and a flexural modulus of 15 GPa or higher.

2. The roller according to claim 1, wherein the shaft further exhibits a glass transition point of 70′ or higher.

3. The roller according to claim 1, wherein the shaft further exhibits a specific gravity of 1.8 or less.

4. The roller according to claim 1, wherein the shaft further exhibits a volume resistivity of 1×10⁵ Ω·cm or less.

5. The roller according to claim 1, wherein the conductive material comprises carbon black.

6. The roller according to claim 1, wherein the resin composition contains the glass fiber in an amount of 10 to 300 parts by mass, and the conducting material in an amount of 0.1 to 20 parts by mass with respect to a total of 100 parts by mass of the aromatic polyamide and the aliphatic polyamide, and a mass ratio of the aromatic polyamide to the aliphatic polyamide is 100:0 to 50:50.

7. The roller according to claim 1, wherein the conductive elastic layer comprises a rubber material selected from the group consisting of silicone rubber, acrylonitrile-butadiene rubber, urethane rubber and ethylene-propylene rubber, as an elastic material.

8. An image forming roller comprising a shaft made of a resin-based material, and an electrically conductive elastic layer provided to cover an outer circumferential surface of the shaft and having a polished surface, the conductive elastic layer being formed of a previously cured electrically conductive rubber tube,
wherein a ratio, de/ds, of an inner diameter de of the tube to an outer diameter, ds, of the shaft is 0.75 to 0.97, and/or a difference, ds−de, between an outer diameter, ds, of the shaft and an inner diameter, de, of the tube is 0.3 mm or more but 2.5 mm or less.

9. The roller according to claim 8, wherein the outer circumferential surface of the shaft and an inner circumferential surface of the tube are in direct contact with each other.

10. The roller according to claim 8, wherein the shaft is made of a resin composition containing an aromatic polyamide, a glass fiber, an electrically conductive material and optionally an aliphatic polyamide, and exhibits a bending strength of 250 MPa or higher and a flexural modulus of 15 GPa or higher.

11. The roller according to claim 10, wherein the resin composition contains the glass fiber in an amount of 10 to 300 parts by mass and the conducting material in an amount of 0.1 to 20 parts by mass, with respect to a total of 100 parts by mass of the aromatic polyamide and the aliphatic polyamide, and a mass ratio of the aromatic polyamide to the aliphatic polyamide is 100:0 to 50:50.

12. The image forming roller according to claim 8, wherein the conductive elastic layer comprises a rubber material selected from the group consisting of silicone rubber, acrylonitrile-butadiene rubber, urethane rubber and ethylenepropylene rubber, as an elastic material.
